(19) United States
(12) Patent Application Publication
(10) Pub. No.: US 2003/0063235 A1
(43) Pub. Date: Apr. 3, 2003

(54) Liquid crystal display with lighting unit for uniform irradiation of liquid crystal panel

(75) Inventors: Yasunari Nakaoka, Kyoto (JP); Takayuki Ishihara, Kyoto (JP); Masanori Komura, Kyoto (JP)

Correspondence Address: MERCHANT & GOULD PC, P.O. BOX 2903, MINNEAPOLIS, MN, 55402-0903, US

(73) Assignee: ROHM CO., LTD., KYOTO-SHI (JP)

(21) Appl. No.: 10/236,469

(22) Filed: Sep. 5, 2002

(30) Foreign Application Priority Data
Sep. 7, 2001 (JP) 2001-272306

(51) Int. Cl. G02F 1/1335

(52) U.S. Cl. 349/65; 349/63

(57) ABSTRACT

A lighting unit for a liquid crystal panel includes a light guide plate and a light source to emit light into the light guide plate. The light guide plate includes an obverse and a reverse surfaces spaced in a thickness direction. The light guide plate further includes a pair of first side surfaces extending in parallel between the obverse and the reverse surfaces, and a second side surface extending transversely of the first side surfaces. The obverse surface of the light guide plate is formed with a plurality of inclined surfaces for causing the light rays travelling within the light guide plate longitudinally to be reflected towards the reverse surface. Each of the first side surfaces of the light guide plate includes a light-inlet portion inclining at an acute angle to the second side surface. The light source is disposed to face the light-inlet portion.

### BACKGROUND OF THE INVENTION

1. The Field of the Invention

The present invention relates to a liquid crystal display. In particular, the present invention relates to a preferable lighting unit for irradiation of a liquid crystal panel, and to a light guide plate as a component of the lighting unit.

2. Description of the Related Art

FIGS. 5 and 6 depict an example of conventional front-lighted liquid crystal displays. The liquid crystal display shown in these figures includes a point light source 7, a liquid crystal panel 8, and a light guide plate 9 provided in front of the liquid crystal panel 8. A reflector 80 is provided on the back of the liquid crystal panel 8. The light guide plate 9, made of a transparent synthetic resin, includes a flat reverse surface 90b and an obverse surface 90a formed unevenly with a plurality of projections 91. Each of the projections 91 includes two inclined surfaces 91a, 91b inclining in different directions. The light source 7 faces a side surface 90c of the light guide plate 9.

In the above structure, the light emitted from the light source 7 enters the light guide plate 9 through the side surface 90c to travel towards another side surface 90d. Some light rays are reflected on the inclined surfaces 91a of the projections 91 towards the reverse surface 90b. Some of the light rays that have reached the reverse surface 90b are reflected thereon whereas the other light rays are released out of the light guide plate 9. The light rays that have released outside irradiate the liquid crystal panel 8.

In conventional liquid crystal displays, the side surface 90c of the light guide plate 9 is simply formed in a plain surface. This configuration causes problems below. The amount of light emitted from the light source is large in front thereof whereas it is small in other region. Consequently, the light is released from the reverse surface 90b of the light guide plate 9 unevenly thereby failing to irradiate the liquid crystal panel 8 uniformly. As a result, the quality of the image display on the liquid crystal panel 8 is deteriorated.

### SUMMARY OF THE INVENTION

The present invention is proposed under the circumstances described above, whereby an object thereof is providing a lighting unit capable of irradiating an object more uniformly than the conventional lighting unit. Another object of the present invention is providing a liquid crystal display incorporating such a lighting unit.

A first aspect of the present invention provides a lighting unit comprising a light guide plate, and a light source emitting light into the light guide plate. The light guide plate includes an obverse and a reverse surfaces spaced in a thickness direction, a pair of first elongated side surfaces extending in parallel to each other between the obverse and the reverse surfaces, and a second side surface extending transversely to the first side surfaces. The obverse surface of the light guide plate is formed with a plurality of inclined surfaces for causing light rays travelling in a longitudinal direction of the first side surfaces in the light guide plate to be reflected towards the reverse surface of the light guide plate. Each of the first side surfaces of the light guide plate includes a light-inlet portion inclining at an acute angle to the second side surface. The light source is disposed to face the light-inlet portion.

Preferably, the light source comprises a light-emitting diode including a light-emitting surface which is disposed in parallel to the light-inlet portion.

Preferably, the second side surface is formed with a plurality of grooves which reflect the light emitted from the light source in a longitudinal direction of the first side surfaces.

Preferably, the respective inclined surfaces incline at an angle in range of 42°-45° to the reverse surface of the light guide plate.

A second aspect of the present invention provides a liquid crystal display comprising a liquid crystal panel and a lighting unit for irradiation of the liquid crystal panel. The lighting unit is provided in accordance with the first aspect of the present invention.

A third aspect of the present invention provides a light guide plate comprising an obverse and a reverse surfaces spaced in a thickness direction, and two side surfaces extending in parallel to each other between the obverse and the reverse surfaces. The obverse surface is formed with a plurality of inclined surfaces for causing light rays travelling from one of the side surfaces towards the other side surface to be reflected towards the reverse surface. The respective inclined surfaces incline at an angle in range of 42°-45° to the reverse surface of the light guide plate.

Other features and advantages of the present invention will be clarified in a detailed description below.

### BRIEF DESCRIPTION OF THE DRAWINGS

FIG. 1 is a sectional view showing a basic structure of a liquid crystal display in accordance with the present invention.

FIG. 2A is a top plan view showing a light guide plate employed in the liquid crystal display in FIG. 1.

FIG. 2B is an enlarged view showing a principal portion of the light guide plate in FIG. 2A.

FIGS. 3A-3L are graphs showing light reflectivity within the light guide plate.

FIG. 4 is a view illustrating a method employed in obtaining the data shown in FIGS. 3A-3L.

FIGS. 5 and 6 are views illustrating functions of a conventional light guide plate employed in a liquid crystal display.

### DESCRIPTION OF THE PREFERRED EMBODIMENTS

Preferred embodiments of the present invention are described below in detail with reference to the accompanying drawings.

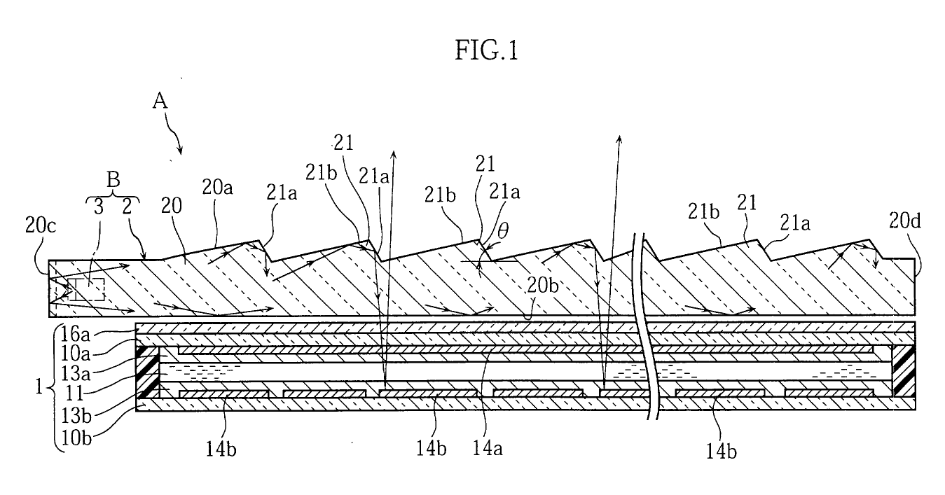

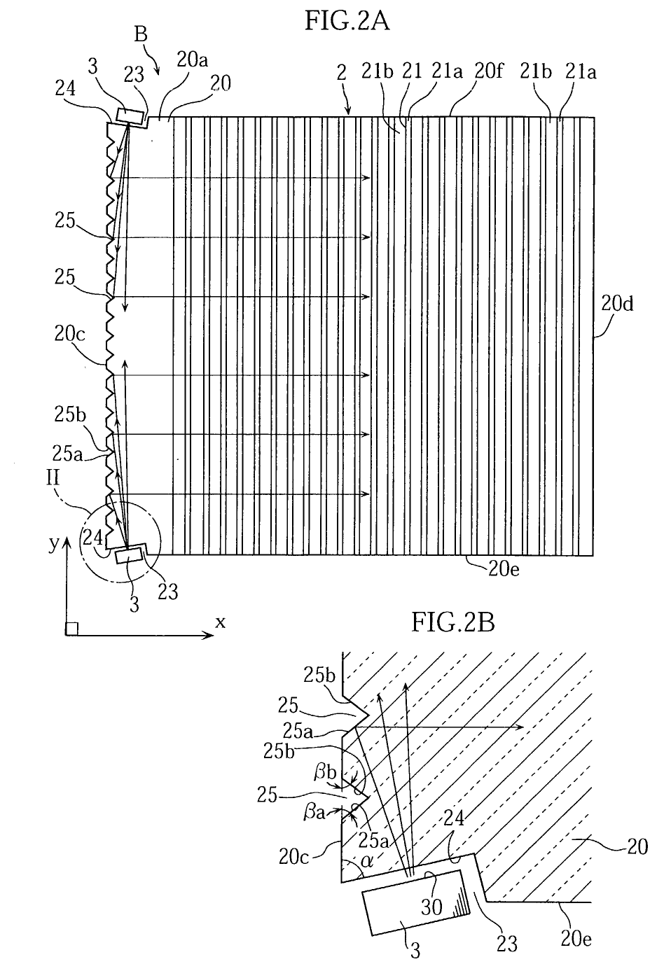

FIG. 1 depicts a basic composition of a liquid crystal display A in accordance with the present invention. The liquid crystal display A is a front-lighted reflective liquid crystal display comprising a liquid crystal panel 1 and a lighting unit B. As shown in FIG. 2, the lighting unit B comprises a light guide plate 2 and two point light sources 3.

The light guide plate 2 includes a light-permeating member 20 made of a transparent synthetic resin. The light-permeating member 20 includes an obverse surface 20a and a reverse surface 20b which are spaced in the thickness direction (FIG. 1). As shown in FIG. 2A, the light-permeating member 20 also includes first side surfaces 20e, 20f extending in the x-direction, and second side surfaces 20c, 20d in the y-direction. These side surfaces are formed into specular surfaces to totally reflect light rays.

As shown in FIG. 1, the reverse surface 20b of the light-permeating member 20 is a plain surface. On the other hand, the obverse surface 20a thereof is unevenly formed with a plurality of projections 21. Each of the projections 21 includes a first and a second inclined surfaces 21a, 21b. The first inclined surfaces 21a reflect light rays impinging thereon in a way such that the light rays meet the reverse surface 20b at a small angle. The first inclined surfaces 21a respectively incline at an angle θ to the reverse surface 20b, where the angle θ may be 43° for example. The second inclined surfaces 21b prevent the light leakage out of the light guide panel 2 by totally reflecting as much light as possible.

As shown in FIG. 2A, the side surfaces 20e, 20f are respectively formed with a notch 23. Each of the notches 23, located close to the side surface 20c, is respectively formed with a light-inlet surface 24 for the light rays emitted from the light sources to pass through upon entrance of the light guide plate 2. The light-inlet surfaces 24 are inclined at an acute angle α (FIG. 2B) to the side surface 20c. The angle α may be approximately 80-84° for example. Though the illustrated light-inlet surface 24 is flat, it may alternatively be formed as a curved surface.

Light-emitting diodes (LED) may be utilized for the respective point light sources 3 for example. Specifically, LED bare-chip may be employed without modification or with a transparent resin packaging. Each of the light sources 3 includes a light-emitting surface 30 facing the corresponding light-inlet surfaces 24 in parallel thereto. In order to keep the lighting unit B compact, the light sources 3 may preferably be fully or partially accommodated in the corresponding notches 23.

The side surface 20c of the light guide plate 2 is formed with a plurality of V-shaped grooves 25 with a suitable interval therebetween. The respective intervals need not be even. Each of the grooves 25 includes two wall surfaces 25a, 25b respectively inclining at suitable angles of βa, βb (FIG. 2B) to the plain face of the side surface 20c. Thereby, the light rays travelling from the light sources 3 are totally reflected in a substantially perpendicular direction to the plain face of the side surface 20c (i.e. substantially in parallel to the side surfaces 20e, 20f). For reflecting light rays accurately in such direction, the angles βa, βb of the respective grooves 25 may preferably be adjusted depending on the distance from the light sources 3 thereto. Though not shown in the figures, the side surface 20d and the side surfaces 20e, 20f (with exception of the light-inlet surfaces 24) may be formed with light reflective layers to prevent light leakage. Such light reflective layers may be formed by vapor deposition of aluminum or application of white paint.

The liquid crystal panel 1 comprises a conventionally known structure. As shown in FIG. 1, the liquid crystal panel 1 includes a pair of substrates 10a, 10b made of glass or resin, filled with a liquid crystal 11 therebetween. The first substrate 10a includes an inner surface provided with a plurality of electrodes (scanning electrodes) 14a and a first alignment layer 13a. Likewise, the second substrate 10b includes an inner surface provided with a plurality of electrodes (signal electrodes) 14b and a second alignment layer 13b. A polarizer 16a is provided in front of the first substrate 10a. The passive matrix drive (passive drive) is employed as a driving method. Each of the scanning electrodes 14a extends in a horizontal direction of FIG. 1. Each of the signal electrodes extends perpendicularly to the scanning electrodes. Pixels are provided at the intersections of the electrodes 14a and 14b.

The first substrate 10a is transparent and the respective scanning electrodes 14a are transparent electrodes made of ITO (indium tin oxide). By contrast, the respective signal electrodes 14b are made of metal to reflect the light rays. In the liquid crystal panel 1, the light rays travel through the polarizer 16a, the first substrate 10a, and the liquid crystal 11 before reflected on the signal electrodes 14b. The liquid crystal panel 1 in accordance with the present invention may be provided with a reflective surface on the back thereof instead of employing reflective electrodes.

A description is given below of functions of the liquid crystal display A of the above-mentioned structure.

Referring to FIG. 2A, the light rays emitted from the respective light sources 3 enters the light guide plate 2 through the light-inlet surfaces 24 to be totally reflected on the side surface 20c. Thereafter, the light rays travel from the side surface 20c towards the side surface 20d. As shown in FIG. 1, the light rays travelling towards the side surface 20d are totally reflected on the inclined surfaces 21a, 21b of the obverse surface 20a or on the reverse surface 20b. Those totally reflected on the first inclined surfaces 21a will change the travelling direction thereof drastically to head the reverse surface 20b. Meeting the reverse surface 20b at an angle smaller than the critical angle of total reflection, the light rays are released out of the light guide plate 2 downwardly to irradiate the liquid crystal panel 1. Thereafter, the light rays travel within the liquid crystal panel 1 before being reflected on the signal electrodes 14b.

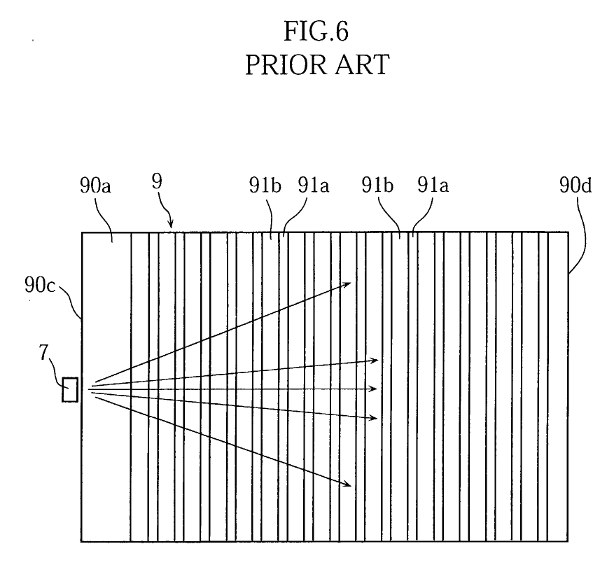

As in the above, the light emitting surfaces 30 of the respective light sources 3 are parallel to the light-inlet surfaces 24. Therefore, most of the light emitted from the light sources 3 passes through the light-inlet surfaces allowing an adequate amount of light to be introduced into the light guide plate 2. The light-emitting surfaces 30 of the respective light sources 3 incline at a predetermined angle to the side surface 20c. Thus the light emitted from the light sources 3 efficiently reaches the substantially whole region longitudinal of the side surface 20c. Moreover, referring to FIG. 2A, the beams of light which is reflected on the side surface 20c travel towards the side surface 20d in parallel to each other. Therefore, in comparison with the conventional structure (FIG. 6), the light is evenly distributed in the light guide panel 2. The distribution of light released through the reverse surface 20b of the light guide plate 2 varies little accordingly so that the image display region of the liquid crystal panel 1 may be irradiated uniformly.

For this embodiment, the tilt angle θ of the first inclined surfaces 21a is determined to be 43° The efficiency of irradiation on the liquid crystal panel 1 is improved accordingly as in the description below.

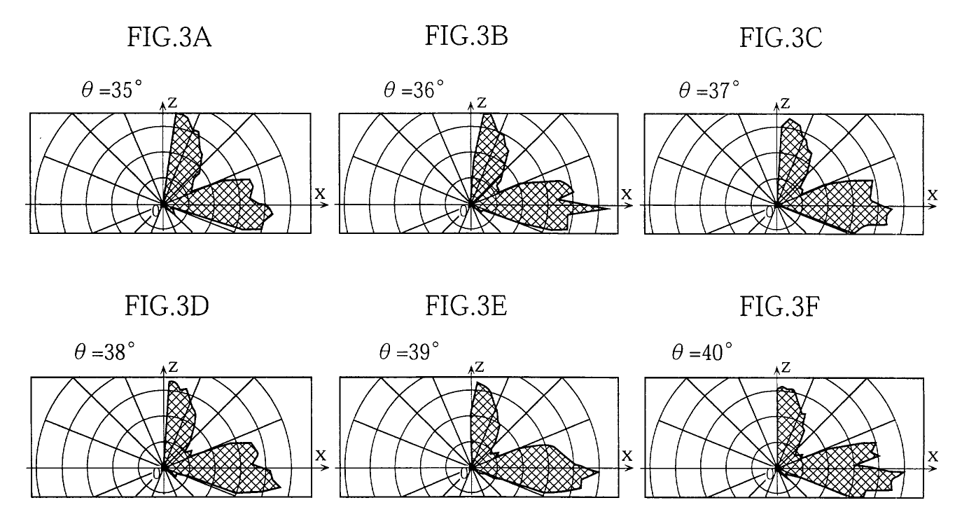

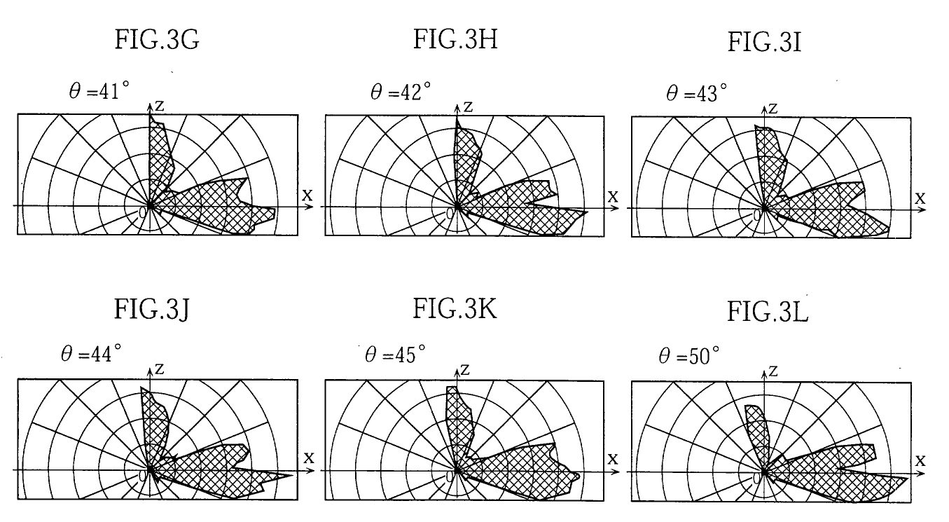

FIGS. 3A-3L depict results obtained by simulations for detecting the light rays track in the lighting unit B described above, in each case the first inclined surfaces 21a have a different tilt angle θ. Specifically, the data shown in these figures are obtained in the following manner.

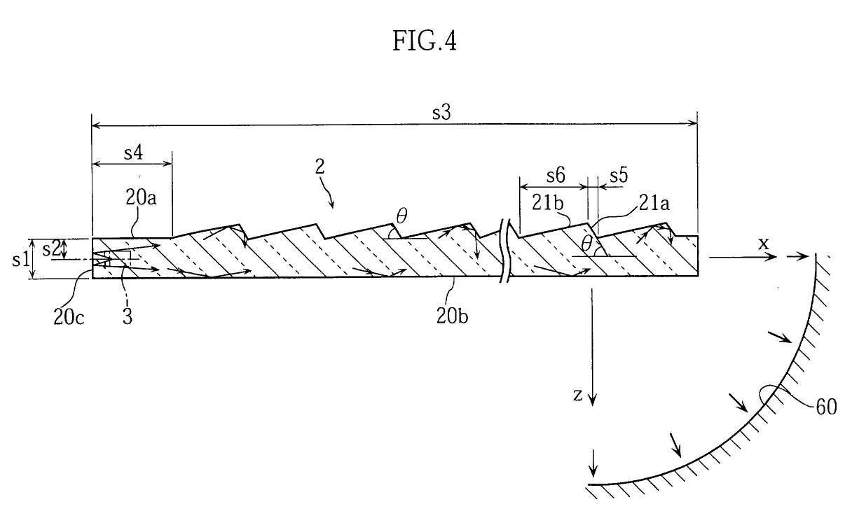

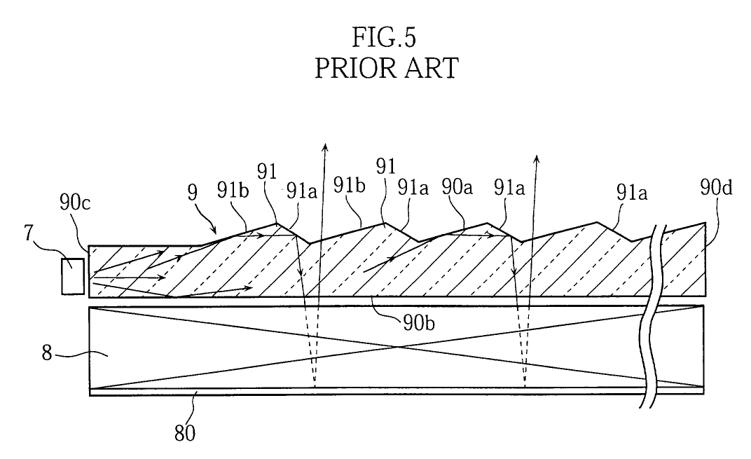

A description is given in reference to FIG. 4. First, one of the first inclined surfaces 21a of the light guide plate 2 is selected. A curved light-receiving surface 60 is provided to receive the light reflected on the selected surface, wherein the relationship between the reflected direction and the amount of light is recorded. This kind of detection is performed for several angles θ (in an example shown, θ=35°, 36°, 37°, 38°, 39°, 40°, 41°, 42°, 43°, 44°45°, 50°). In a following step, similar detections are performed on a plurality of first inclined surfaces 21a. The averages derived of the data obtained in this manner are plotted on graphs in FIGS. 3A-3L. Specifically, the outline of the darkened area in the graphs represents the light amount, where an outline further from the origin 0 implies a larger amount (the dimensionless amount) of light. The x-axis of the graphs corresponds to the x-direction in FIG. 4, whereas the z-axis of the graphs corresponds to the z-direction in FIG. 4. The z-direction shows a directly downward direction from the selected surface, that is, a downward normal direction from the reverse surface 20b.

The light guide plate 2 employed in the simulation includes measurements s1-s6 (FIG. 4) given below. The measurement s1 (the thickness of the light guide plate 2) is 11.0 mm. The measurement s2 (the height from the midst of the light source 3 up to the obverse surface 20a) is 0.5 mm. The measurement s3 (the full length of the light guide plate 2 in the x-direction) is 43.65 mm. The measurement s4 (the distance between the side surface 20c and the second inclined surface 21b nearest thereto) is 6.55 mm. The measurements s5 (the width of the first inclined surface 21a) and s6 (the width of the second inclined surface 21b) are variables determined by the angle θ, providing s5=10 μm and s6=140 μm when θ=45°. Note that s5+s6=150 μm whatever the angle θ is. The light guide plate 2 (light-permeating member 20) is made of “ZEONOAH 1420R (trade name)” manufactured by the Zeon Co.

FIGS. 3A-3G show the cases when the tilt angle θ is between 35°-41°, where the light reflected in the z-direction (refer to FIG. 4) is almost zero. In contrast, FIGS. 3H-3K show the cases when the tilt angle θ is between 42°-45°, where a great amount of light is reflected in the z-direction. FIG. 3L where the angle θ is 50°, however, shows the peak amount of light off to the left of the z-axis (i.e. the light amount travelling in the z-direction decreases). Further, when θ=50°, the peak amount of light is relatively small. This result arises from the increase in the amount of light released outside through the first inclined surfaces 21a.

As understood from the data above, setting the angle θ in range of 42°-45° allows the light rays to meet the reverse surface 20b of the light guide plate 2 in a perpendicular direction. Moreover, the data show that the maximum amount of light travels in the z-direction when the angle θ is 43°. It is advantageous to release more light from the reverse surface 20b of the light guide plate 2 perpendicularly in this way for efficiently irradiating the image display region of the liquid crystal panel 1.

The preferred embodiments of the present invention being thus described, it is obvious that the same may be varied in various ways. Such variations should not be regarded as a departure from the spirit and scope of the invention, and all such variations as would be obvious to those skilled in the art are intended to be included within the scope of the claims given below.

1. A lighting unit comprising:
a light guide plate including an obverse and a reverse surfaces spaced in a thickness direction, a pair of first elongated side surfaces extending in parallel to each other between the obverse and the reverse surfaces, and a second side surface extending transversely of the first side surfaces; and
a light source to emit light into the light guide plate;
wherein the obverse surface of the light guide plate is formed with a plurality of inclined surfaces for causing light rays travelling in a longitudinal direction of the first side surfaces in the light guide plate to be reflected towards the reverse surface of the light guide plate;
wherein each of the first side surfaces of the light guide plate includes a light-inlet portion inclining at an acute angle to the second side surface, the light source being disposed to face the light-inlet portion.

2. The unit according to the claim 1, wherein the light source comprises a light-emitting diode including a light-emitting surface which is disposed in parallel to the light-inlet portion.

3. The unit according to the claim 1, wherein the second side surface is formed with a plurality of grooves which reflect the light emitted from the light source in a longitudinal direction of the first side surfaces.

4. The unit according to the claim 1, wherein the respective inclined surfaces incline at an angle in range of 42°-45° to the reverse surface of the light guide plate.

5. A liquid crystal display comprising a liquid crystal panel and a lighting unit for irradiation of the liquid crystal panel,
wherein the lighting unit comprising:
a light guide plate including an obverse and a reverse surfaces spaced in a thickness direction, a pair of first elongated side surfaces extending in parallel to each other between the obverse and the reverse surfaces, and a second side surface extending transversely of the first side surfaces; and
a light source to emit light into the light guide plate;
wherein the obverse surface of the light guide plate is formed with a plurality of inclined surfaces for causing light rays travelling in a longitudinal direction of the first side surfaces in the light guide plate to be reflected towards the reverse surface of the light guide plate;
wherein each of the first side surfaces of the light guide plate includes a light-inlet portion inclining at an acute angle to the second side surface, the light source being disposed to face the light-inlet portion.

6. A light guide plate comprising:
an obverse and a reverse surfaces spaced from each other in a thickness direction; and
two side surfaces extending in parallel to each other between the obverse and the reverse surfaces;
wherein the obverse surface is formed with a plurality of inclined surfaces for causing light rays travelling from one of the side surfaces towards the other side surface to be reflected towards the reverse surface;
wherein the respective inclined surfaces inclining at an angle in range of 42°-45° to the reverse surface of the light guide plate.
